(19) United States
(12) Patent Application Publication
(10) Pub. No.: US 2021/0149985 A1
(43) Pub. Date: May 20, 2021

(54) METHOD AND APPARATUS FOR PROCESSING LARGE-SCALE DISTRIBUTED MATRIX PRODUCT

(71) Applicant: Daegu Gyeongbuk Institute of Science and Technology, Daegu (KR)

(72) Inventors: Min-Soo KIM, Seongnam-si (KR); Dong Hyoung HAN, Daegu (KR); Sung Jin LEE, Daegu (KR)

(21) Appl. No.: 17/093,718

(22) Filed: Nov. 10, 2020

(30) Foreign Application Priority Data
Nov. 19, 2019 (KR) 10-2019-0148945

(51) Int. Cl. G06F 17/16; G06F 7/523; G06F 9/50; G06T 1/20

(52) U.S. Cl. CPC G06F 17/16; G06F 7/523; G06T 1/20; G06F 9/5016; G06F 9/5061

(57) ABSTRACT

A matrix multiplication calculation apparatus of the disclosure includes an auxiliary memory device storing a first input matrix and a second input matrix, a cuboid candidate determining module generating a plurality of cuboid candidates and a plurality of subcuboid candidates based on the first input matrix, the second input matrix, a central processing unit (CPU) memory size, and a graphics processing unit (GPU) memory size, a cuboid size determining module configured to determine a size of the plurality of cuboids based on the CPU memory size from among the plurality of cuboid candidates, and determine a size of the plurality of subcuboids based on the GPU memory size from among the plurality of subcuboid candidates, a matrix partitioning module partitioning the first input matrix and the second input matrix to the plurality of cuboids based on the size of the plurality of cuboids determined in the cuboid size determining module, a matrix multiplication calculation module performing matrix multiplication calculation on the plurality of subcuboids obtained based on the size of the plurality of subcuboid determined in the cuboid size determining module, and a matrix block accumulation module accumulating matrix multiplication calculation on the plurality of subcuboids obtained from the matrix multiplication calculation module.

### CROSS-REFERENCE TO RELATED APPLICATION

This application is based on and claims priority under 35 U.S.C. § 119 to Korean patent application number 10-2019-0148945, filed on Nov. 19, 2019, in the Korean Intellectual Property Office, the disclosure of which is incorporated by reference herein in its entirety.

### BACKGROUND

### 1. Field

The disclosure relates to a method of processing a large-scale distributed matrix multiplication by using a graphics processing apparatus and an apparatus thereof. More specifically, the disclosure relates to a method of performing a matrix multiplication calculation with low communication costs by using the graphic processing apparatus and an apparatus thereof.

### 2. Description of Related Art

Matrix multiplication has widely been used as a basic operator which is the basis of most algorithms in the field of computer science from modern recommendation systems and machine learning to traditional linear systems and graphic renderings.

Recently, with the matrix data sizes used in recommendation systems and machine learning increasing, it has become difficult to perform matrix multiplication computing in a node. Accordingly, the importance of distributed matrix multiplication method is becoming more emphasized recently due to the advantages in being able to process matrix multiplication computing by distributing matrices to calculation nodes by utilizing parallelization and distribution matrix systems in which calculation nodes are connected via the network.

However, there is the limitation of costs for the exorbitant amount of memory required and network costs required in order to perform the distributed matrix multiplication. Accordingly, there is a need for technology that does not require a significant amount of cost for the exorbitant amount of memory and for network costs in performing the matrix multiplication calculation.

### SUMMARY

An aspect of the disclosure is to provide a method for performing matrix multiplication calculation effectively regardless of the size of a matrix and hardware performance and an apparatus thereof.

As aspect of the disclosure is to provide a method for performing a large-scale matrix multiplication calculation while utilizing system resources maximally and an apparatus thereof.

However, these aspects are merely exemplary, and the disclosure is not limited to the aspects described above.

According to an embodiment, a matrix multiplication calculation apparatus includes an auxiliary memory device which stores a first input matrix and a second input matrix, a cuboid candidate determining module which generates a plurality of cuboid candidates and a plurality of subcuboid candidates based on the first input matrix, the second input matrix, a size of a central processing unit (CPU) memory, and a size of a graphics processing unit (GPU) memory), a cuboid size determining module configured to determine the size of the plurality of cuboids, and determine the size of the cuboids which determines the size of the plurality of subcuboids based on the size of the GPU memory from among the plurality of subcuboid candidates, a matrix partitioning module which partitions the first input matrix and the second input matrix to the plurality of cuboids based on a size of a plurality of cuboids determined in the cuboid size determining module, a matrix multiplication calculation module which performs matrix multiplication calculation on the plurality of subcuboids obtained based on the size of the plurality of subcuboids determined in the cuboid size determining module, and a matrix accumulated total module which accumulates the matrix multiplication calculation on the plurality of subcuboids obtained from the matrix multiplication calculation module.

The auxiliary memory device according to an embodiment may further store a plurality of intermediate result matrices generated from the result of matrix multiplication on the plurality of subcuboids in the matrix multiplication calculation module and the result matrix generated by accumulating the plurality of intermediate result matrices in the matrix block accumulation module.

The cuboid size determining module according to an embodiment may be configured to determine the size of the plurality of cuboids based on the communication cost between the main memory device and the auxiliary memory device and the CPU memory size, and determine the size of the plurality of subcuboids based on the communication cost between the CPU and the GPU and the GPU memory size.

The matrix partitioning module according to an embodiment may be configured to generate a 3-dimensional space based on a dimension of the first input matrix and a dimension of the second input matrix, generate a 3-dimensional model corresponding to multiplication calculation between the first input matrix and the second input matrix, and generate the plurality of cuboids by partitioning the 3-dimensional model.

The matrix multiplication calculation module according to an embodiment may be configured to perform the matrix multiplication calculation on the plurality of subcuboids in parallelization by using a stream of the GPU.

According to an embodiment, a matrix multiplication calculation method includes receiving a first input matrix and a second input matrix, generating a 3-dimensional space based on a first axis corresponding a row dimension of the first input matrix, a second axis corresponding to a column dimension of the first input matrix, and a third axis corresponding to a column dimension of the second input matrix, generating a 3-dimensional model corresponding to a multiplication calculation between the first input matrix and the second input matrix of a 3-dimensional phase space, partitioning the 3-dimensional model to a plurality of cuboids based on a size of a CPU memory, partitioning each of the plurality of cuboids to a plurality of subcuboids based on a size of a GPU memory, generating an intermediate result matrix by obtaining a multiplication calculation result between matrix elements corresponding to each of the plurality of subcuboids by using GPU and using the multiplication calculation result between the obtained matrix elements, and generating a result matrix by accumulating the intermediate result matrix using CPU.

The column dimension of the second input matrix according to an embodiment may be the same as the row dimension of the first input matrix.

The cuboid according to an embodiment may be comprised of a plurality of voxels, and voxel v_{i,j,k} may correspond to the multiplication calculation between matrix element (i, k) of the first input matrix and the matrix element (k, j) of the second input matrix.

The result matrix according to an embodiment may be comprised of matrix element (i, j) corresponding to a total of a plurality of voxels.

The partitioning to the plurality of cuboids according to an embodiment may include partitioning the 3-dimensional model to the plurality of cuboids based on a communication cost between the main memory device of the CPU and the auxiliary memory device of the CPU and the CPU memory size.

The partitioning to the plurality of subcuboids according to an embodiment may include partitioning the each of the plurality of cuboids to the plurality of subcuboids based on a communication cost between the CPU and the GPU and the GPU memory size.

According to an embodiment, a computer program may be configured store in a recordable medium to execute any one method of claims 1 to 5 using a computer.

According to another embodiment without being limited to the above, the distributed matrix multiplication method may, based on having two matrices each with I×K blocks and K×J blocks as input matrices and generating a result of matrix with I×J blocks, include a step of cuboid based partitioning of input matrices; step of graphics processing unit based matrix multiplication based on the cuboids; and a step of matrix accumulated total for generating intermediate result blocks which is the result of the cuboids as accurate result matrix blocks.

According to an embodiment, the matrix calculation system to which the distributed matrix multiplication is applied is operated in a parallel processing machine, and may include a plurality of central processing units controlling each step, a main memory device temporarily storing some blocks of the input matrices, a graphics processing unit calculating matrix multiplication, and an auxiliary memory device storing all input matrices and result matrices.

According to an embodiment, the matrix calculation system may be managed through a control group. The control group may be one thread of a central processing unit in the case of a parallel processing machine, and may be a machine corresponding to a master node of a master-slave structure for a distributed processing system in the case of a small-scale cluster comprised of a plurality of machines.

In an embodiment, the control group may include a cuboid based matrix partitioning device performing the cuboid based partitioning step; a graphics processing computing device calculating each cuboid by using a plurality of streams in the graphics processing unit to perform a step of the graphics processing unit based matrix multiplication; and a matrix accumulated total computing device for performing the step of matrix accumulated total.

In an embodiment, the cuboid based matrix partitioning device may, based on size, sparsity, dimension, and the like of meta information of input matrices from the user or the system and a total number of cores, number of nodes, the size of the main memory device capable of being used by the core, the size of the graphics processing unit capable of using the core, or the like, which is a system information, include a cuboid candidate determining module; a cuboid size determining module which selects a parameter of an optimum cuboid partitioning method in the candidates; and a matrix partitioning module on input matrices utilizing the parameter.

In an embodiment, the cuboid candidate determining module may, if the input factor is a matrix, represent the matrix multiplication as a 3-dimensional model and determine the cuboid candidate on all cases where partitioning of a 3-dimensional model to a plurality of cuboid forms is performed, and if the input factor is a cuboid, determine a sub cuboid candidate for all cases where partitioning of the corresponding cuboid to a plurality of sub cuboids is performed.

In an embodiment, the cuboid size determining module may determine a cuboid size by selecting a candidate generating minimal communication cost from among candidates that determine a cuboid size appropriate to a size of a main memory device which is useable for each core while searching for corresponding candidates when cuboid candidates are received from a cuboid candidate determining module, and determine a sub cuboid size by selecting a candidate which is a match to the size of a usable graphic main memory device and minimizes communication costs between the main memory device and the graphics processing unit from among the corresponding candidates when a sub cuboid candidate is received.

In an embodiment, the matrix partitioning module may form the input matrices as a plurality of cuboids based on a parameter determined in the cuboid size determining module, and allocate each of the cuboids to the responsible cores or nodes via hash based or an arbitrary method.

In an embodiment, the graphics processing computing device may include a stream module which manages streams of the graphics processing unit; and a matrix multiplication calculation module which calculates sub cuboids in the graphics processing unit.

In an embodiment, the stream module may manage a plurality of streams which allows the execution of the graphics processing unit to be performed asynchronously.

In an embodiment, the matrix multiplication calculation module may form cuboids to a plurality of subcuboids based on the parameter determined for partitioning subcuboids in the cuboid based matrix partitioning device and calculate the matrix multiplication with respect to the subcuboid by utilizing a portion from among the streams managed in the stream module.

In an embodiment, the matrix accumulated total computing device may perform the matrix accumulated total step, which is the last step of the distributed matrix multiplication by using the matrix block accumulation module which calculates the accumulated total by shuffling between the cores or nodes to generate the intermediate result matrix blocks of the cuboids calculated in the graphics processing computing device as result matrices.

In an embodiment, the matrix calculation system may be comprised of a plurality of central processing units, a plurality of graphics processing units connected with a main memory device through a PCI_E and SATA interface, and an auxiliary memory device. The core of the graphics processing unit and the memory devices (e.g., main memory device and graphic main memory device) may use all of the available memory size by using the core, which is a calculation resource included in the central processing unit of the matrix calculation system and the stream which is included in the graphics processing unit. The main memory device may be loaded with a plurality of cuboids, and the graphic main memory device may be loaded with a plurality of subcuboids.

In an embodiment, the memory device and the core which are each calculation resources may receive allocations of cuboids, perform the forming of the corresponding cuboids to subcuboids by selecting an optimum parameter according to the size of the graphic main memory device usable by the corresponding core, and calculate matrix multiplication in the cores of the graphics processing unit by the streams of the graphics processing unit in the order of minimized data transmission, and each of the streams after calculation by the subcuboids is complete may transmit the intermediate result blocks from the graphic main memory device to the main memory device.

In an embodiment, the core of the central processing unit may store the result matrix blocks in the auxiliary memory device after performing the accumulated total calculation by shuffling the intermediate result blocks.

According to an embodiment comprised as described above, matrix multiplication calculation on matrices larger than the size of the memory devices capable of being used in the parallel processing machine may be performed.

According to an embodiment, the method of performing matrix multiplication may include performing matrix multiplication calculation with effective communication cost by using a predetermined cost based model based on information on input matrices.

In order to use the graphics processing unit which cannot be used when performing distributed matrix multiplication in a conventional system, matrix multiplication on a matrix larger than the size of the graphic main memory device may be possible through a theoretically identical cuboid based partitioning method, but the disclosure is not limited to the effects described herein.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating a matrix calculation system comprising a matrix multiplication calculation device according to an embodiment of the disclosure;

FIG. 2 is a table illustrating symbols and meanings used in the drawings of the disclosure;

FIG. 3 is a flowchart illustrating a matrix multiplication calculation method according to an embodiment of the disclosure;

FIG. 4, as a diagram for describing in detail some operations of FIG. 3, is a flowchart illustrating a cuboid based matrix partitioning method according to an embodiment of the disclosure;

FIG. 5, as a diagram for describing in detail some operations of FIG. 4, is a flowchart illustrating a method of selecting an optimum parameter for cuboid based matrix partitioning according to an embodiment of the disclosure;

FIG. 6, as a diagram for describing in detail some operations of FIG. 4, is a diagram illustrating a method of partitioning an input matrix using the selected parameter according to an embodiment of the disclosure;

FIG. 7, as a diagram for describing in detail some operations of FIG. 3, is a flowchart illustrating a graphics processing unit based matrix multiplication method according to an embodiment of the disclosure;

FIG. 8, as a diagram for describing in detail some operations of FIG. 7, is a flowchart illustrating a method of selecting an optimum parameter for determining a subcuboid according to an embodiment of the disclosure;

FIG. 9, as a diagram for describing in detail some operations of FIG. 7, is a flowchart illustrating a method of partitioning a cuboid to a plurality of subcuboids according to an embodiment of the disclosure;

FIG. 10, as a diagram form describing in detail some operations of FIG. 7, is a flowchart illustrating a matrix multiplication calculation method with respect to blocks comprised in subcuboids in a graphics processing unit according to an embodiment of the disclosure;

FIG. 11, as a diagram form describing in detail some operations of FIG. 3, is a diagram illustrating a method of matrix accumulated total in a distributed matrix multiplication method according to an embodiment of the disclosure; and

FIG. 12 A and FIG. 12 B are an example diagram illustrating an example of a cuboid based matrix partitioning method according to an embodiment of the disclosure.

### DETAILED DESCRIPTION

The various embodiments of the disclosure will be described with reference to the accompanying drawings. Various modifications may be made to the various embodiments and various embodiments may be included, and thus a specific embodiment may be illustrated in the drawings and described in the detailed description. However, it should be noted that the various embodiments are not for limiting the scope of the disclosure to a specific embodiment, but they should be interpreted to include all modifications, equivalents or alternatives of the embodiments included in the ideas and the technical scopes disclosed herein. Further, in the description of the drawings, like reference numerals indicate like components.

It is to be understood that the expressions such as “comprise” or “may comprise” are used herein to designate a presence of a corresponding function, operation, element, or the like in the disclosure, and not to limit additional one or more functions, operations or elements. In addition, the terms such as “include” or “have” are used herein to designate a presence of a characteristic, number, step, operation, element, component, or a combination thereof, and not to preclude a presence or a possibility of adding one or more of other characteristics, numbers, steps, operations, elements, components or a combination thereof.

In the various embodiments, the expressions such as “or” may include some or all combinations of the terms listed together. For example, “A or B” may include A, or B, or both A and B.

The expressions such as “first,” “second,” “1st,” “2nd,” and so on may be used to describe a variety of elements, but the elements should not be limited by these terms. For example, the expressions should not limit the order and/or importance of the corresponding elements. The expressions are used only for the purpose of distinguishing one element from another. For example, a first user device and a second user device may both be user devices, or may represent the devices of different users. For example, a first element may be designated as a second element without exceeding the scope of the disclosure, and likewise the second element may be designated as the first element.

When a certain element is indicated as being “coupled with/to” or “connected to” another element, it is to be understood as the certain element being directly coupled with/to or connected to the other element or as being coupled through still another element. On the other hand, when a certain element is indicated as “directly coupled with/to” or “connected to” another element, it is to be understood as still another element not being present between the certain element and the other element.

The terms used in the various embodiments herein have merely been used to describe a specific embodiment, and not to limit the scope of the various embodiment described herein. A singular expression may include a plural expression, unless otherwise specified.

Unless otherwise specified, all terms used herein, including technical or scientific terms, may have the same meaning as the terms generally understood by those of ordinary skill in the related field of art to which the various embodiments pertain.

The terms which are generally used and defined in a typical dictionary may be interpreted to meanings identical or similar to the contextual meanings thereof in the related art. Unless clearly defined otherwise in the various embodiments, the terms may not be interpreted to ideal or excessively formal meanings.

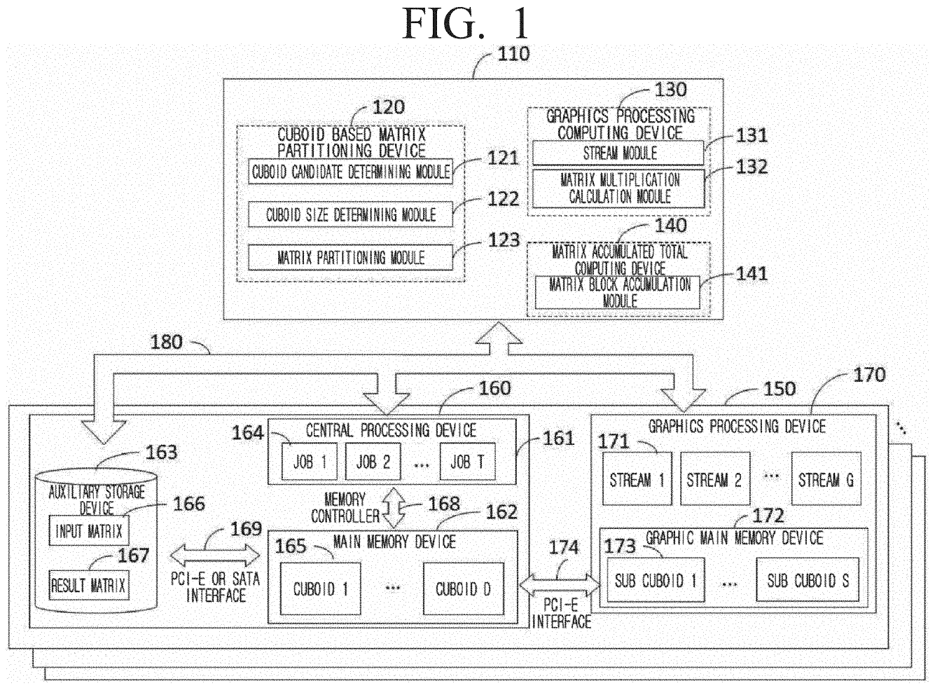

FIG. 1 is a diagram illustrating a structure of a matrix calculation system according to an embodiment of the disclosure. Referring to FIG. 1, the matrix calculation system 100 which performs the matrix multiplication calculation according to an embodiment of the disclosure may include a control group 110 and a hardware apparatus 160 and 170. In addition, the matrix multiplication calculation apparatus performing matrix multiplication calculation according to another embodiment may include a control group 110. The control group 110 according to an embodiment may be configured to receive a first input matrix and a second input matrix, generate a 3-dimensional space based on a first axis corresponding to a row dimension of the first input matrix, a second axis corresponding to a column dimension of the first input matrix, and a third axis corresponding to a column dimension of a second input matrix, generate a 3-dimensional model corresponding to a multiplication calculation between the first input matrix and the second input matrix of the 3-dimensional phase space, divide the 3-dimensional model to a plurality of cuboids based on a size of a CPU memory, divide each of the plurality of cuboids to a plurality of subcuboids based on a size of a GPU memory, obtain a multiplication calculation result between matrix elements corresponding to each of the plurality of subcuboids by using GPU, generate an intermediate result matrix by using the multiplication calculation result between the obtained matrix elements, and generate a result matrix by accumulating the intermediate result matrix by using CPU.

Specifically, in an embodiment, the control group 110 may include a cuboid based matrix partitioning device 120 performing a cuboid based partitioning step, a graphics processing computing device 130 calculating each cuboid by using a plurality of streams in the graphics processing unit to perform the graphics processing unit based matrix multiplication step, and a matrix accumulated total computing device 140 performing the matrix accumulated total step.

In an embodiment, the cuboid based matrix partitioning device 120 may, based on system information comprising the number of blocks on each dimension of input matrices from the user or system, sparsity, number of cores of meta information computing apparatuses of an input matrix comprising a size of a matrix, number of nodes, size of a main memory device capable of being used by a core, and size of a graphic memory device capable of being used by the graphics processing unit, include a cuboid candidate determining module 121 which determines a cuboid, a cuboid size determining module 122 which identifies a parameter of a cuboid partitioning method based on the cuboid candidate obtained in the cuboid candidate determining module 121, and a matrix partitioning module 123 which partitions the input matrices to each core by using the parameter identified in the cuboid size determining module 122.

In an embodiment, the cuboid candidate determining module 121 may generate a plurality of cuboid candidates and a plurality of subcuboid candidates based on a first input matrix, a second input matrix, a size of a CPU memory, and a size of a GPU memory.

First, the cuboid candidate determining module 121 may represent the matrix multiplication between input matrices as a 3-dimensional model by using the plurality of input matrices. More specifically, the cuboid candidate determining module 121 may, with respect to the first input matrix and the second input matrix comprised in the plurality of input matrices, define a 3-dimensional space based on a first axis corresponding to a row dimension of the first input matrix, a second axis corresponding to a column dimension of the first input matrix, and a third axis corresponding to a column dimension of the second input matrix. Then, the cuboid candidate determining module 121 may generate a 3-dimensional model corresponding to multiplication calculation between the first input matrix and the second input matrix of the 3-dimensional phase space.

In an embodiment, the cuboid candidate determining module 121 may obtain a cuboid candidate for all cases where partitioning of a 3-dimensional model to a plurality of cuboid forms is performed. In another embodiment, the cuboid candidate determining module 121 may obtain a subcuboid candidate for all cases where partitioning of a cuboid to a plurality of subcuboid candidates is performed.

In an embodiment, the cuboid size determining module 122 may determine the size of the plurality of cuboids based on the size of the CPU memory from among the plurality cuboid candidates, and determine the size of the plurality of subcuboids based on the size of the GPU memory from among the plurality of subcuboid candidates.

In an embodiment, the cuboid size determining module 122 may receive a plurality of cuboid candidates from the cuboid candidate determining module 121. In the embodiment, the cuboid size determining module 122 may determine the size of the main memory device capable of being used by each core and the size of the cuboid based on communication cost. For example, the cuboid size determining module 122 may determine the size of the cuboid by selecting a parameter which generates a minimum communication cost from parameter candidates suitable for the size of the main memory device capable of being used by each core.

In another embodiment, the cuboid size determining module 122 may receive a plurality of subcuboid candidates from the cuboid candidate determining module 121. In the embodiment, the cuboid size determining module 122 may determine the size of the subcuboid based on the size of the usable graphic main memory device and the communication cost between main memory device and the graphics processing unit. For example, the cuboid size determining module 122 may determine the size of the subcuboid by using a parameter which minimizes communication cost between the main memory device and the graphics processing unit from among the parameters suitable for the size of the usable graphic main memory device.

In an embodiment, the matrix partitioning module 123 may partition the input matrices 166 into a plurality of cuboids 165 in the auxiliary memory device 163 based on a parameter identified in the cuboid size determining module. Then, the matrix partitioning module 123 designates the cores (or nodes) of the computing apparatus which is to perform a calculation on the above-described plurality of cuboids.

The graphics processing computing device 130 may include a stream module 131 which manages streams 171 of the graphics processing unit and a matrix multiplication calculation module 132 which calculates subcuboids in the graphics processing unit.

In an embodiment, the stream module 131 may be configured to asynchronously perform the execution of the graphics processing unit 170 by using a plurality of streams 171.

The matrix multiplication calculation module 132 may perform matrix multiplication with respect to the subcuboid by using the streams 171 managed in the stream module 131.

The matrix accumulated total computing device 140 may include a matrix block accumulation module 141 which calculates the accumulated total by performing a shuffle between the cores or the nodes to generate the intermediate result matrices of the cuboids calculated by the graphics processing computing device 130 as result matrices.

In an embodiment, the matrix block accumulation module 141 may generate result matrix blocks by accumulating the blocks of the intermediate result matrix, and obtain a final result matrix of matrix multiplication calculation therefrom.

In an embodiment, the matrix multiplication calculation apparatus may include a computing apparatus 160 and a graphics processing unit 170. The computing apparatus 160 and the graphics processing unit 170 may be connected through a PCI-E interface 174.

In an embodiment, the computing apparatus 160 may include a plurality of central processing units 161, a main memory device 162, and at least one of an auxiliary memory device 163. The central processing unit (central processing device) 161 may allocate jobs 164 performed in the matrix multiplication calculation to each of the cores. For example, the central processing unit 161 may allocate an input matrix 166 to each of the cores by using the parameter identified in the cuboid size determining module 122.

The number of the above-described jobs 164 may be identified according to the parallelization level and the number of cores included in the central processing unit 161. The main memory device 162 may store the plurality of cuboids 165 generated from the cuboid based matrix partitioning device 120. The central processing unit 161 and the main memory device 162 may be connected to and communicate with one another through a memory controller 168. In addition, the central processing unit 161 and the main memory device 162 may be connected through a PCI-E or SATA interface 169. However, the configuration of the computing apparatus 160 performing the matrix multiplication calculation according to some embodiments and the connection relationship between the configurations may not be limited thereto, and each configuration may be connected through various interfaces capable of being designed and modified by those skilled in the art. However, even in this case, the auxiliary memory device 163 connected to at least all calculation nodes may be of capacity larger than the size of the final result matrix 167.

The graphics processing unit (graphics processing device) 170 may include streams 171 for executing the cores of the graphics processing unit and a graphic main memory device 172. The graphic main memory device 172 may store subcuboids 173 obtained from the cuboid based matrix partitioning device 120.

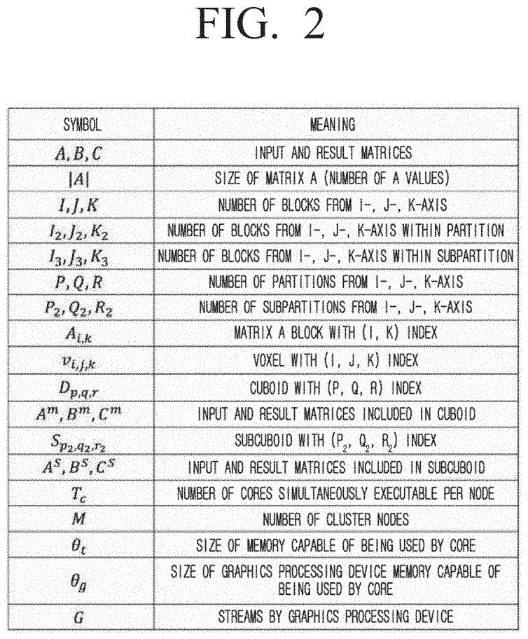

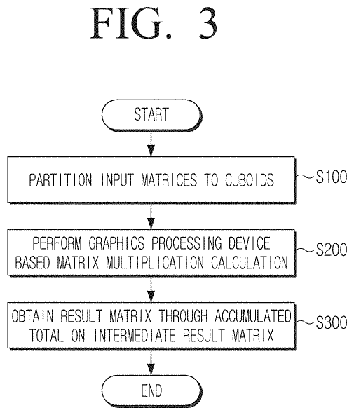

The meaning of the symbols used for describing the matrix multiplication calculation method according to some embodiments through FIGS. 3 to 12 below, may be based on the meanings according to the table illustrated in FIG. 2.

FIG. 3 is a flowchart illustrating a matrix multiplication calculation method according to an embodiment of the disclosure.

The matrix multiplication calculation method according to an embodiment partitions the input matrices to cuboids (S100), performs matrix multiplication calculation by using the graphics processing unit with respect to the obtained plurality of cuboids (S200), and then obtains a result matrix through an accumulated total on the intermediate result matrix obtained through each cuboid (S300). The detailed steps performed in each step may be described in detail below.

In step S100, the cuboid based matrix partitioning device 120 may partition the input matrix 166 of the auxiliary memory device 163 and store as a plurality of cuboids 165 in the main memory device 162.

More specifically, the cuboid based matrix partitioning device 120 may receive the first input matrix and the second input matrix, generate a 3-dimensional space based on a first axis corresponding a row dimension of the first input matrix, a second axis corresponding to a column dimension of the first input matrix, and a third axis corresponding to a column dimension of the second input matrix, and generate a 3-dimensional model corresponding to a multiplication calculation between the first input matrix and the second input matrix of a 3-dimensional phase space.

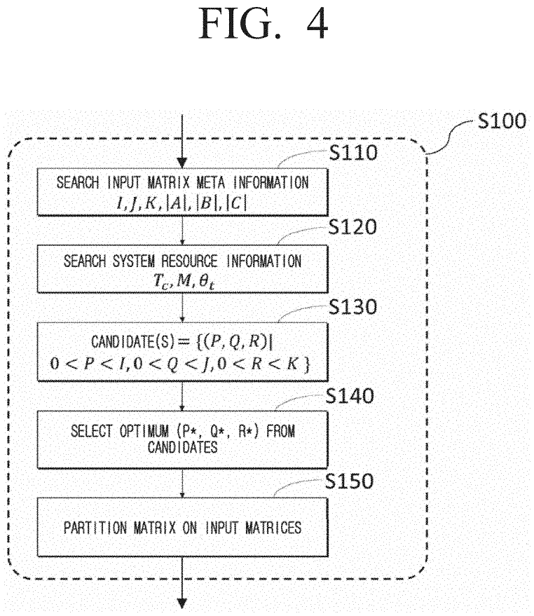

Then, the cuboid based matrix partitioning device 120 may partition the 3-dimensional model to a plurality of cuboids based on the CPU memory size. The method of partitioning the cuboid will be described with reference to FIG. 4.

Then, each of the plurality of cuboids in step S200 may be partitioned to a plurality of subcuboids based on the GPU memory size, the multiplication calculation result between the matrix elements corresponding to each of the plurality of subcuboids may be obtained by using the GPU, and an intermediate result matrix may be generated by using the multiplication calculation result between the obtained matrix elements.

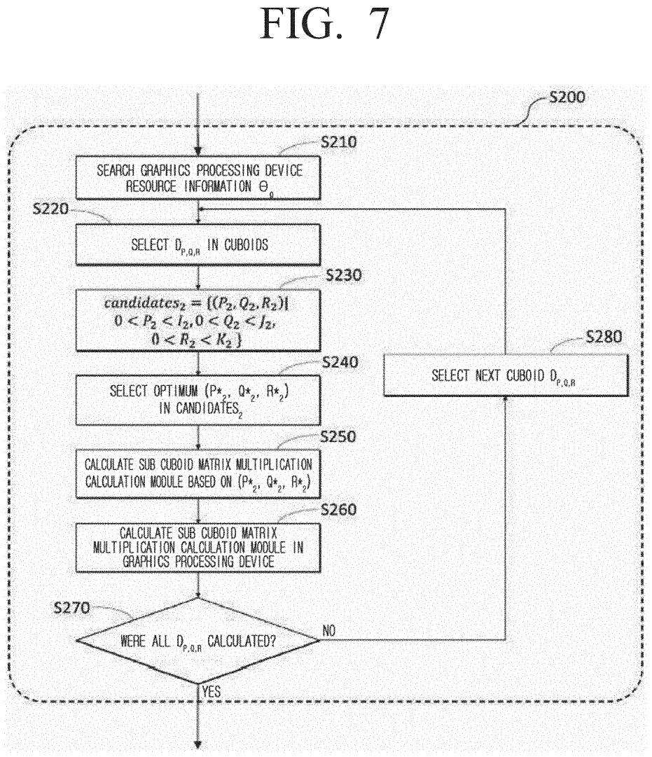

The plurality of cuboids 165 which has been described in greater detail may be partitioned to subcuboids based on resource information of the graphics processing unit 170. Then, the graphics processing computing device 130 may store the subcuboids 173 in the graphic main memory device 172 by using the streams 171. In addition, the graphics processing computing device 130 may perform matrix multiplication calculation on each of the subcuboids 173. The method of performing matrix multiplication calculation by using the graphics processing unit will be described in detail with reference to FIG. 7.

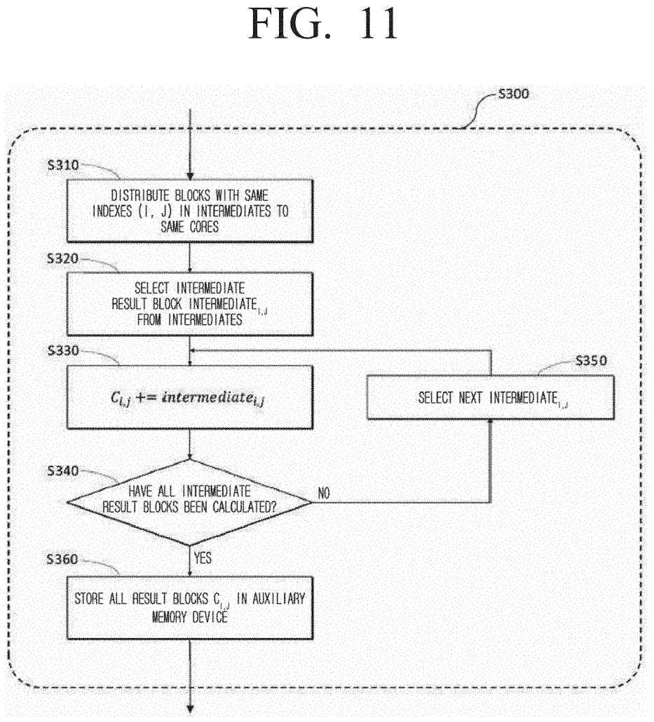

In step S300, the matrix accumulated total computing device 140 may generate a result matrix by accumulating the intermediate result matrices obtained from the graphics processing unit 170. The method of calculating the accumulated total of the intermediate result matrices will be described with reference to FIG. 11.

Below, the process of partitioning the input matrices to cuboids according to an embodiment will be described below with reference to FIG. 4. The method of partitioning input matrices to a plurality of cuboids according to some embodiments may be determined so that the size of the cuboid is as same as possible with the size of the usable main memory device and the communication cost is minimized based on the meta information of the input matrix and the system resource information.

In step S110, information on the number of blocks (I, J, K) on each dimension of the input matrices and the sizes (|A|, |B|, |C|) of the input matrices and the result matrices may be obtained.

In step S120, information on the size (θₜ) of the memory of the main memory device usable in each core, the total number of nodes (M), the number of cores capable of being executed simultaneously for each node (T_{c}), which are system resources, may be obtained.

In step S130, candidates on P, Q, R parameter which is to determine the size of the cuboid may be generated by using information on the number of blocks on each dimension. Each candidate may be formed of three integers (P, Q, R), and each integer may have a range of 0<P<I, 0<Q<J, 0<R<K.

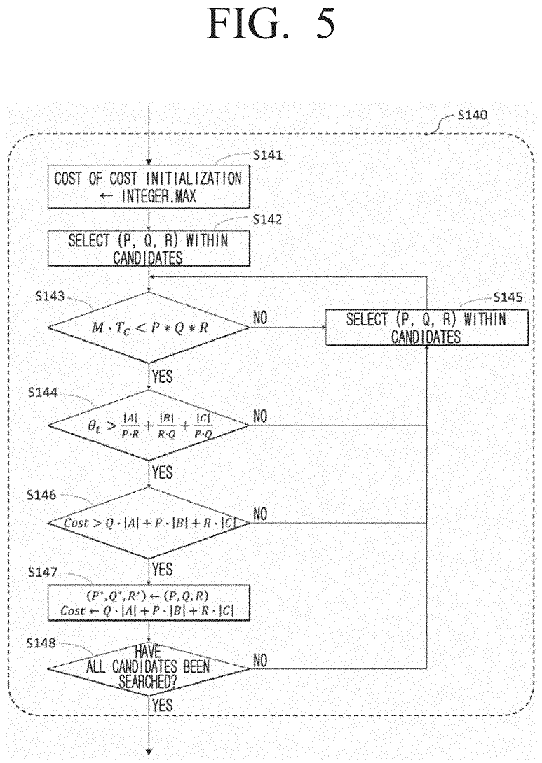

In step S140, (P*, Q,* R*) determining the optimum cuboid size of matching the size of the usable memory and minimizing communication cost from among the candidates may be selected from among the candidates on the above-described P, Q, R parameter. The method of selecting an optimum parameter will be described with reference to FIG. 5.

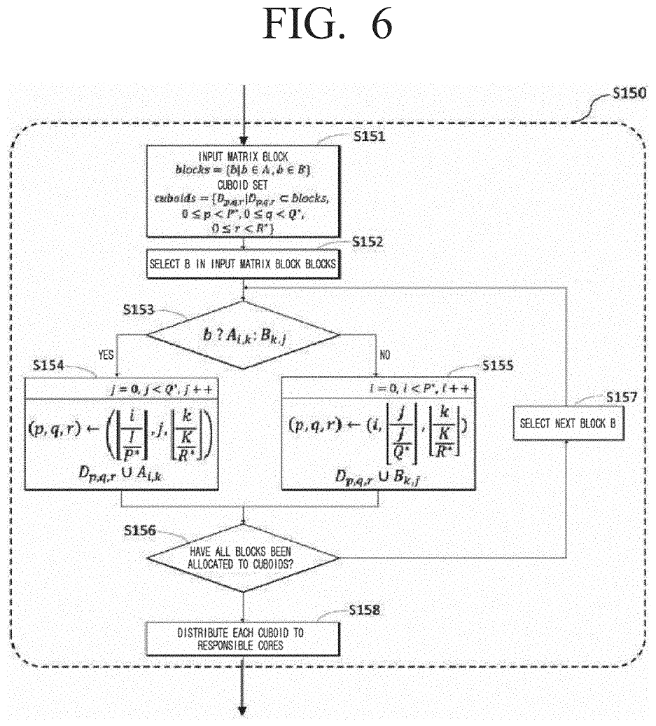

In step S150, the input matrices may be partitioned to a plurality of cuboids by using an optimum parameter. The method of partitioning the input matrices will be described in detail with reference to FIG. 6.

FIG. 5 is a flowchart illustrating a method of determining an optimum cuboid size according to the status of the input matrices and the system resources according to an embodiment of the disclosure. The size of the cuboid identified according to an embodiment may be a size that is smaller than or equal to the size (θₜ) of the usable main memory device and minimizes communication cost.

In an embodiment, the total number of cuboids may be determined to a number larger than the number of usable cores in the system for maximally using the system parallelization level (M·T_{C}) (S143). In this case, the size of the cuboid may be calculated as an average number of elements per cuboid in the input matrices and the result matrices (S144), and the communication cost according to an embodiment may be determined by the number of replications of input matrices and output matrices in each cuboid (S146).

More specifically, in step S141, a variable Cost may be initialized to compare the communication cost of the selected candidate. In addition, in step S142, one from among the candidates with respect to the P, Q, R parameter generated in step S130 may be selected.

In step S143, whether the number of cuboids to be generated by the selected candidate (P, Q, R) is greater than or equal to the total parallelization level (M·T_{C}) may be checked. In an embodiment, if the corresponding candidate is greater than the total parallelization level step S144 may be performed, and in another embodiment, if the corresponding candidate is smaller than the total parallelization level, the next candidate may be selected if smaller (S145).

In step S144, whether the size of the cuboid to be generated by the selected candidate (P, Q, R) is smaller than the size (θₜ) of the main memory device usable in the core may be checked. If the selected candidate according to an embodiment is larger than the size of the usable main memory device, the next candidate may be selected (S145).

In step S146, whether the communication cost to be generated by the selected candidate (P, Q, R) is smaller than the Cost may be checked. If the communication cost to be generated by the selected candidate (P, Q, R) is greater than the Cost, the next candidate may be selected (S145).

Because the candidate (P, Q, R) selected in step S147 is identified as the most optimum from among the candidates viewed so far, the current candidate may be determined as the optimum candidate (P*, Q,* R*) and the optimum Cost.

In step S148, whether all candidates have been searched in step S148 may be checked, and if not all candidates have been searched, the next candidate may be selected (S145).

FIG. 6 is a flowchart illustrating a process of partitioning the input matrices to a plurality of cuboids by using the selected optimum parameter (P*, Q,* R*), and distributing the each of the partitioned cuboids to each of a plurality of cores.

In step S151, the each of the input matrices may be stored as a set of blocks in the main memory device 162 by using the input matrix, and then the set cuboids with respect to the cuboids D_{p,q,r} to be formed may be initialized.

In step S152, one block b may be selected from the blocks.

In step S153, it may be possible to check where the selected block b belongs in which input matrix.

Then, in step S154, if the selected block b is a block of matrix A, block b may be allocated to the corresponding cuboids by calculating index (p, q, r) of Q* number of cuboids to be allocated.

In addition, in step S155, if the selected block b is a block of matrix B, block b may be allocated to the corresponding cuboids by calculating index (p, q, r) of P* number of cuboids to be allocated.

In step S156, whether all of the blocks have been allocated to the cuboid may be checked. In an embodiment, if all the of blocks have not been allocated to the cuboid, the next block may be selected (S157), and if all have been allocated, the plurality of cuboids allocated with a plurality of blocks may be distributed to each of the plurality the cores (S158).

FIG. 7 is a diagram illustrating a method of partitioning the obtained plurality of cuboids to the plurality of subcuboids by using the cuboid based matrix partitioning device 120 according to an embodiment of the disclosure.

In an embodiment, the size of subcuboids may select an optimum parameter (P*₂, Q*₂, R*₂) to determine the size of the subcuboids which is smaller than the size (θ_{g}) of the graphic main memory device of the usable graphics processing unit and minimizes communication cost between the main memory device and the graphics processing unit.

More specifically, in step S210, the graphics processing computing device 130 may obtain information on the size θ_{g} of the graphic main memory device of the usable graphics processing unit.

Then, in step S220, cuboid D_{p,q,r} may be selected from the set cuboids.

Then, in step S230, a candidate with respect to parameter P₂, Q₂, R₂ for determining the size of the subcuboids may be generated. The parameter candidate for determining the size of the subcuboid may be formed of three integers (P₂, Q₂, R₂), and each integer may be determined from a range of 0<P₂<I₂, 0<Q₂<J₂, 0<R₂<K₂.

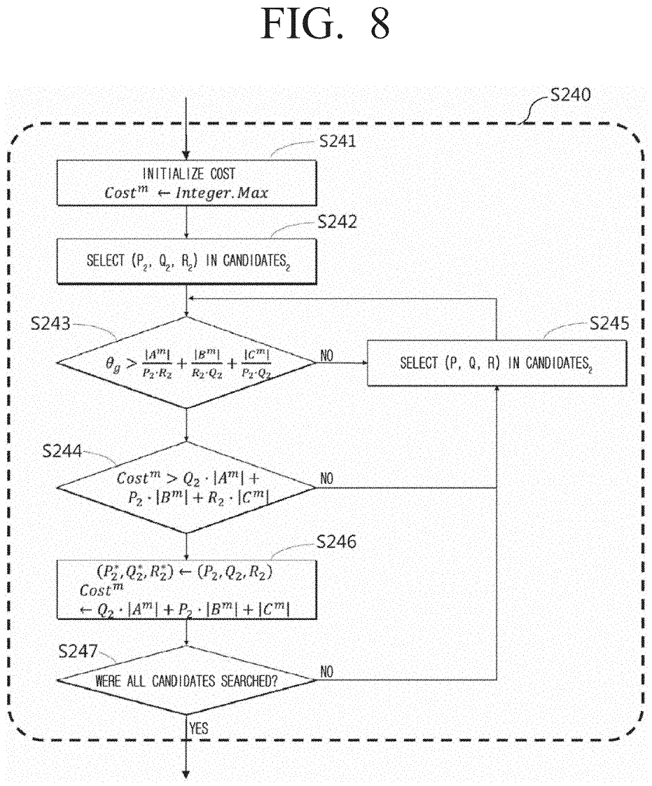

In step S240, an optimum parameter (P*₂, Q*₂, R*₂) determining the size of the subcuboid which is a match to the size of the usable graphics memory device and minimizes communication costs from among the candidates of parameter (P₂, Q₂, R₂) may be selected. The method of selecting the above-described optimum parameter will be described in detail with reference to FIG. 8.

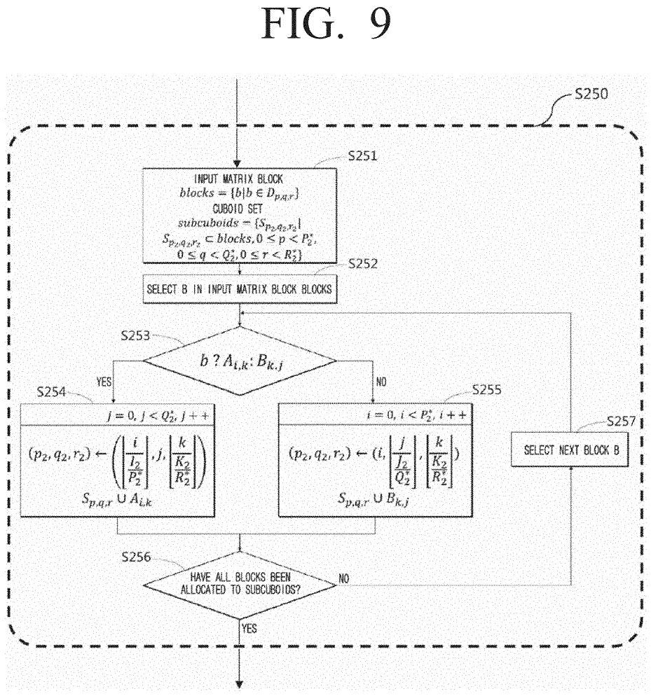

In step S250, the plurality of cuboids may be partitioned to subcuboids by using the parameter obtained in step S240. The detailed description will be described below with reference to FIG. 9.

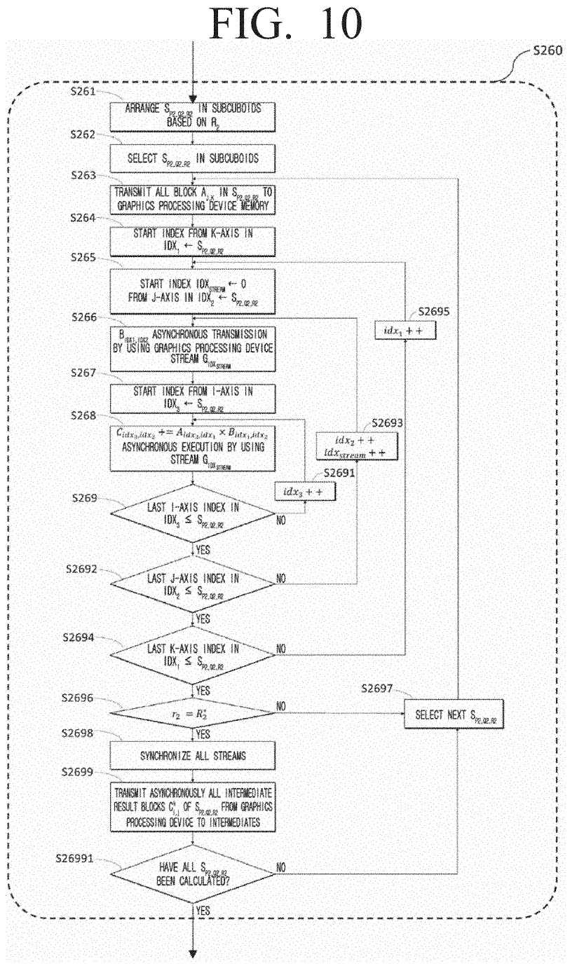

In step S260, a matrix multiplication calculation on subcuboids may be performed by using the streams of the graphics processing unit. The detailed description will be described below with reference to FIG. 10.

In step S270, whether matrix multiplication calculation has been performed on all cuboids may be checked. In an embodiment, if calculation has not been completed on all cuboids, the next cuboid may be selected (S280).

FIG. 8 is a diagram illustrating a method of determining the optimum subcuboid size according to the status of the cuboids and the graphics processing unit according to an embodiment of the disclosure.

The size of the subcuboid determined according to an embodiment may be a size which is smaller than the size (θ_{g}) of the usable graphic memory device and minimizes the communication cost between the main memory device and the graphics processing unit.

In an embodiment, the size of the subcuboids may be calculated by an average number of elements per subcuboid from the input matrices and the result matrices in the cuboid, and the communication cost may be determined by the number of replications of input matrices in the cuboid to each subcuboid. In addition, the number of replications on the intermediate result matrices of subcuboids may be replicated only once by the calculation order on the subcuboids in the graphics processing unit.

In step S241, the variable Cost^{m} for comparing the communication cost of the selected candidate may be initialized.

In step S242, the parameter of the candidate (P₂, Q₂, R₂) selected from among the candidates generated in step S230 may be obtained.

In step S243, whether the size of the subcuboids which is determined by the selected candidate parameter (P₂, Q₂, R₂) is smaller than the size θ_{g} of the usable graphic memory device may be checked.

In step S245, if the corresponding candidate parameter (P₂, Q₂, R₂) is greater than the size of the usable main memory device, the next candidate parameter may be selected.

In step S244, whether the communication cost where the selected candidate parameter (P₂, Q₂, R₂) may check whether the communication cost to be generated is smaller than Cost^{m} may be checked.

In an embodiment, the selected candidate parameter (P₂, Q₂, R₂) may be generated is greater than Cost^{m}, select the next candidate parameter (S245).

In step S246, the current candidate parameter (P₂, Q₂, R₂) may be identified as the optimum candidate (P*₂, Q*₂, R*₂) and optimum Cost^{m}.

In step S247, whether all candidates have been searched may be checked. In an embodiment, if all candidates have not been searched, the next candidate may be selected (S245).

FIG. 9 is a diagram illustrating a method of partitioning the cuboid to the subcuboid by using the selected optimum parameter (P*₂, Q*₂, R*₂) according to an embodiment of the disclosure.

In step S251, the input matrices in cuboid D_{p,q,r} may be stored as a set of blocks, and the set subcuboids to be formed as subcuboids may be initialized.

In step S252, one block b is selected from the blocks.

In step S253, the selected block b being a block belonging to which input matrix may be checked (S253).

In step S254, if the selected block b is a block of matrix A, index (p₂, q₂, r₂) of Q*₂ number subcuboids to be allocated may be calculated and allocated to the subcuboid according to an embodiment, and in step S255, if the selected block b is a block of matrix B, index (p₂, q₂, r₂) of P*₂ number subcuboids to be allocated may be calculated and allocated to the subcuboid according to another embodiment of the disclosure.

In step S256, whether all blocks have been allocated to each of the subcuboids may be checked. In an embodiment, if all blocks have not been allocated to each of the subcuboids, the next blocks may be selected (S257).

FIG. 10 is a diagram illustrating a method of performing matrix multiplication calculation by loading the subcuboids 173 to the graphic main memory device 172 through the matrix multiplication calculation module 132 and using the streams 171 according to an embodiment of the disclosure.

In an embodiment, when the blocks of the input matrices in the subcuboid Sₚ_{₂}_{,q}_{₂}_{,r}_{₂} are loaded to the graphic memory device, the blocks of the matrix small in size from among the input matrices may first be stored in the graphic memory device. FIG. 10 illustrates the case where the size of matrix A may be small from among the input matrices according to an embodiment of the disclosure.

In step S261, subcuboids Sₚ_{₂}_{,q}_{₂}_{,r}_{₂} in the set subcuboids may be arranged based on r₂. Through the step above, movement on the intermediate result matrix may be minimized to one time.

In step S262, subcuboids Sₚ_{₂}_{,q}_{₂}_{,r}_{₂} may be selected in subcuboids, in step S263, the blocks on matrix A in the subcuboid Sₚ_{₂}_{,q}_{₂}_{,r}_{₂} may all be stored in the graphic memory device.

Through steps 264 to S2695, the matrix multiplication calculation between all blocks in the subcuboid Sₚ_{₂}_{,q}_{₂}_{,r}_{₂} may be performed through a triple iteration.

First, a first iteration which includes steps S264 to S2694 and S2695 may use a k-axis index idx₁ of subcuboid Sₚ_{₂}_{,q}_{₂}_{,r}_{₂}, and a second iteration including steps 265 to 2692 and S2693 may perform step S266 by using a j-axis index idx₂.

In step S266, the block B_{idx}_{₁}_{,idx}_{₂} of matrix B in the subcuboid Sₚ_{₂}_{,q}_{₂}_{,r}_{₂} may be stored in the graphic main memory device through asynchronous transmission by using stream G_{idx}_{ₛₜᵣₑₐₘ}.

In addition, a third iteration including steps S267 to S269 and S2691 may perform step S268 by using a i-axis index idx₃, and in step S268, the matrix multiplication C_{idx}_{₃}_{,idx}_{₂}+=A_{idx}_{₃}_{,idx}_{₁}×B_{idx}_{₁}_{idx}_{₂} may be asynchronously executed through stream G_{idx}_{ₛₜᵣₑₐₘ}.

In step S2696, whether or not an accumulated total calculation on the results of other subcuboids with respect to the result of the calculated subcuboid Sₚ_{₂}_{,q}_{₂}_{,r}_{₂} no longer needs to be performed may be checked.

In an embodiment, if an accumulated total calculation on the results of other subcuboids no longer needs to be performed, all streams may be synchronized in step S2698, and the result of subcuboid Sₚ_{₂}_{,q}_{₂}_{,r}_{₂} may be stored in the main memory device through step S2699.

In another embodiment, if it is necessary to perform an accumulated total calculation on the results of the other subcuboids with respect to the result of subcuboid Sₚ_{₂}_{,q}_{₂}_{,r}_{₂}, the next subcuboid may be selected (S2697).

In step S26991, whether all subcuboids have been calculated may be checked.

In an embodiment, if all subcuboids have been calculated, the next subcuboid may be selected (S2697).

FIG. 11 is a diagram illustrating a process of accumulating the total to generate result matrix blocks with respect to intermediate results itermediates of the cuboid according to an embodiment of the disclosure.

In step S310, the intermediate blocks with the same index (i, j)) may be distributed to the same cores.

In step S320, intermediate_{i,j} may be selected with respect to all intermediate result blocks, and a calculation accumulating intermediate_{i,j} to result block C_{i,j} may be performed.

Then, in step S340, whether or not all intermediate result blocks have been calculated may be checked. In an embodiment, if all intermediate result blocks have been calculated, the all result blocks C_{i,j} may be stored in the auxiliary memory device 163 in step S360. In another embodiment, if all intermediate result blocks have not been calculated, the next intermediate result intermediate_{i,j} may be obtained (S350).

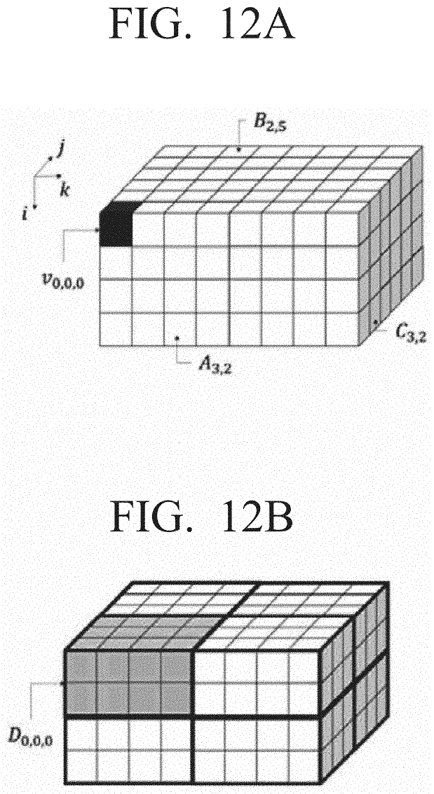

FIG. 12 is a diagram illustrating an example of a matrix multiplication calculation method of according to an embodiment of the disclosure.

The method of partitioning the matrix multiplication on matrix A comprised of 4×6 blocks and matrix B comprised of 6×8 blocks based on the cuboid according to an embodiment will be described below with reference to FIG. 12.

Here, matrix A includes I, K dimension, matrix B includes K, J dimension, and the range of index i, j, k of each dimension may be 0≤i<4, 0≤j<8, 0≤k<6. Thus, the multiplication of matrix A and matrix B may be represented as a 3-dimensional model as in FIG. 12A.

The one cuboid of FIG. 12A may be represented as a voxel, and each voxel may include index (j, k) of a 3-dimensional phase. The black color voxel may be a voxel corresponding to a starting point on the 3-dimensional phase, and may be designated as v_{0,0,0}. The meaning of voxel v_{i,j,k} may refer to A_{i,k}·B_{k,j}.

FIG. 12B illustrates a cuboid that is generated when an example 3-dimensional model is applied to the cuboid based partitioning method by using parameter (2,2,2). The meaning of the parameter values may refer to the number of partitions in each axis of the 3-dimensional model.

As illustrated in FIG. 12B, if the 3-dimensional model illustrated in FIG. 12A is partitioned by using the parameter (2,2,2), two cuboids may be present at each axis and a total of eight cuboids may be generated. Each cuboid may include a 3-dimensional index (p, q, r), and the range of each index may include 0≤p<2, 0≤q<2, 0≤r<2. The cuboid comprised of the grey color voxels in FIG. 12B may include a starting point index, and may be designated as D_{0,0,0}.

The embodiments according to the disclosure described above may be implemented in the form of a computer program capable of being executed through various elements on the computer, and the computer program as described above may be recorded in a non-transitory computer-readable medium. The medium may include a magnetic medium such as a hard disc, a floppy disc, and a magnetic tape, an optical recording medium such as a CD-ROM and DVD, a magneto-optical medium such as a floptical disk, and a hardware device specifically comprised to store and execute program instructions such as a read only memory (ROM), a random access memory (RAM), or a flash memory.

The computer program may be specifically designed and configured for the disclosure, or may be known and usable to those skilled in the field of computer software. An example of the computer program may include not only a machine language code such as those created by a compiler but also high-level language codes executable by a computer by using an interpreter or the like.

The specific embodiments described in the disclosure are provided merely as embodiments, and not to limit the scope of the disclosure in anyway whatsoever. For the sake of brevity, electronic configurations, control systems, software, and disclosures of other functional aspects of the systems according to prior art may be omitted. In addition, linear connections or connecting members between elements illustrated in the drawings represent functional connections and/or physical or circuitry connections by example, and in the actual device the above may be represented as various functional connections, physical connections, or circuitry connects which may be substituted or added. In addition, unless specifically disclosed as “essentially,” “critically,” or the like, the element may not necessarily be essential for the application of the disclosure.

While the disclosure has been described with reference to the embodiments illustrated in the drawings, the embodiments are merely exemplary, and it will be understood by those skilled in the art that various changes in form and details may be made therein without departing from the spirit and scope of the disclosure.

What is claimed is:

1. A matrix multiplication calculation apparatus, comprising:
an auxiliary memory device storing a first input matrix and a second input matrix;
a cuboid candidate determining module generating a plurality of cuboid candidates and a plurality of subcuboid candidates based on the first input matrix, the second input matrix, a central processing unit (CPU) memory size, and a graphics processing unit (GPU) memory size;
a cuboid size determining module configured to determine a size of the plurality of cuboids based on the CPU memory size from among the plurality of cuboid candidates, and determine a size of the plurality of subcuboids based on the GPU memory size from among the plurality of subcuboid candidates;
a matrix partitioning module partitioning the first input matrix and the second input matrix to the plurality of cuboids based on the size of the plurality of cuboids determined in the cuboid size determining module;
a matrix multiplication calculation module performing matrix multiplication calculation on the plurality of subcuboids obtained based on the size of the plurality of subcuboid determined in the cuboid size determining module; and
a matrix block accumulation module accumulating matrix multiplication calculation on the plurality of subcuboids obtained from the matrix multiplication calculation module.

2. The matrix multiplication calculation apparatus of claim 1, wherein the auxiliary memory device further stores a result matrix generated by accumulating a plurality of intermediate result matrices generated as a result of matrix multiplication calculation on the plurality of subcuboids in the matrix multiplication calculation module and the plurality of intermediate result matrices in the matrix block accumulation module.

3. The matrix multiplication calculation apparatus of claim 1, wherein the cuboid size determining module is configured to:
determine a size of the plurality of cuboids based on a communication cost between a main memory device and an auxiliary memory device and the CPU memory size, and
determine a size of the plurality of subcuboids based on a communication cost between the CPU and the GPU and the GPU memory size.

4. The matrix multiplication calculation apparatus of claim 1, wherein the matrix partitioning module is configured to:
generate a 3-dimensional space based on a dimension of the first input matrix and a dimension of the second input matrix,
generate a 3-dimensional model corresponding to a multiplication calculation between the first input matrix and the second input matrix in the 3-dimensional space, and
generate the plurality of cuboids by partitioning the 3-dimensional model.

5. The matrix multiplication calculation apparatus of claim 1, wherein the matrix partitioning module performs in parallel a matrix multiplication calculation on the plurality of subcuboids by using a stream of the GPU.

6. A matrix multiplication calculation method, comprising:
receiving a first input matrix and a second input matrix;
generating a 3-dimensional space based on a first axis corresponding to a row dimension of the first input matrix, a second axis corresponding to a column dimension of the first input matrix, and a third axis corresponding to a column dimension of the second input matrix, and generating a 3-dimensional model corresponding to multiplication calculation between the first input matrix and the second input matrix of the 3-dimensional phase space;
partitioning the 3-dimensional model to a plurality of cuboids based on a CPU memory size;
partitioning each of the plurality of cuboids to a plurality of subcuboids based on a GPU memory size;
obtaining a multiplication calculation result between matrix elements corresponding to each of the plurality of subcuboids by using a GPU, and generating an intermediate result matrix by using the multiplication calculation result between the obtained matrix elements; and
generating a result matrix by accumulating the intermediate result matrix by using a CPU.

7. The method of claim 6, wherein the row dimension of the second input matrix is the same as a column dimension of the first input matrix.

8. The method of claim 6, wherein the cuboid is comprised of a plurality of voxels, and voxel v_{i,j,k} corresponds to multiplication calculation between a matrix element (i, k) of the first input matrix and a matrix element (k, j) of the second input matrix.

9. The method of claim 8, wherein the result matrix is comprised of matrix element (i, j) corresponding to a total of a plurality of voxels.

10. The method of claim 6, wherein the partitioning to the plurality of cuboids comprises partitioning the 3-dimensional model to the plurality of cuboids based on a communication cost between a main memory device of the CPU and an auxiliary memory device of the CPU and the CPU memory size.

11. The method of claim 6, wherein the partitioning to the plurality of subcuboids comprises partitioning each of the plurality of cuboids to the plurality of subcuboids based on a communication cost between the CPU and the GPU and the GPU memory size.

12. A computer program stored in a non-transitory recording medium for executing a method of claim 1 by using a computer.
